(19) United States
(12) Patent Application Publication
(10) Pub. No.: US 2004/0081639 A1
(43) Pub. Date: Apr. 29, 2004

(54) Biological control of fungal contamination by applying geotrichum candidum

(76) Inventor: Patrick Boivin, Messein (FR)

Correspondence Address: YOUNG & THOMPSON, 745 SOUTH 23RD STREET 2ND FLOOR, ARLINGTON, VA, 22202

(21) Appl. No.: 10/370,583

(22) Filed: Feb. 24, 2003

Related U.S. Application Data
(63) Continuation of application No. PCT/FR01/02644, filed on Aug. 21, 2001.

(30) Foreign Application Priority Data
Aug. 22, 2000 (FR) 00/10815

(51) Int. Cl. A01N 63/04

(52) U.S. Cl. 424/93.5

(57) ABSTRACT

A method for preventing or treating cereal contamination or fungi producing mold toxins by applying a micro-organism of the Geotrichum candidum family.

The invention relates to the application of a micro-organism, Geotrichum candidum, in the form of a field spray, for the treatment of cereals contaminated by moulds, in particular by strains of Fusarium.

The present invention is applicable to agriculture.

Diseases of cereals, in particular ear fusarioses, are the source of major damage: loss of yield, degradation of harvest quality and changes in the technological properties of the cereals. Such plant diseases are also the origin of the biosynthesis of mycotoxins found in harvested grain.

All cereals are known to be contaminated by moulds, in particular strains of Fusarium. The principal species of Fusarium found in cereals are the species graminearum, culmorum, sambucinum, poae, proliferatum and nivale. Strains that contaminate cereals produce mycotoxins. As an example, the principal mycotoxins produced by Fusarium are type A and B trichothecenes (deoxynivalenol, nivalenol or T2-toxin, for example), complemented by zearalenone and fumonisins for maize. The nature of mycotoxins depends on the species of Fusarium present. In particular, certain of the mycotoxins resist transformation conditions and can therefore be found in the finished products. Hence, they constitute a food safety risk.

Thus, it is important to prevent ear fusariosis, contamination of grain by mould and the production of mycotoxins when growing cereals.

The principal known means of combating contamination by mould is the treatment of cultures using fungicides. However, the use of fungicides in agriculture poses different problems: fungicides are biologically active chemical and their field application may therefore present toxicological and ecological problems. Further, the low stability of fungicides requires that the treatments be repeated frequently during growth. The treatment must also have a sufficiently broad spectrum of action while remaining limited to fungi. Finally, those treatments are not completely effective for ears (20% to 80% efficacy) and it is low for grain (0 to 30% efficacy). Further, observations recently carried out on different batches of cereals have shown that a large proportion of the batches still show a significant mycotoxin content after treatment with several hundred micrograms per kg.

Thus, there is a genuine need for developing methods for treating contamination by moulds which constitute alternatives to fungicidal treatment.

By sowing a microorganism that does not produce mycotoxins, the present invention aims to inhibit the development of fungal flora and in particular species of Fusarium contaminating ears and grain, and the production of secondary fungal metabolites such as mycotoxins.

Similar treatment methods have been described in the prior art (International publication WO-A-91/01641, United States patents U.S. Pat. No. 4,842,871, U.S. Pat. No. 5,668,008) under the title “biological control” and comprise using a non-pathogenic microorganism that does not produce mycotoxins on agricultural products to limit the development of undesirable microbial flora.

In particular, the use of selected non-pathogenic micro-organisms has been proposed to reduce the development of fungal malt house flora. As an example, lactic bacteria are used to reduce the development of fungal flora and more precisely Fusarium (WO-A-94/16053). The use of the strain Geotrichum candidum naturally present in barley during germination and on the finished malt has also been proposed, firstly to inhibit the development of toxicogenic flora during malting, and secondly to improve the biochemical and physico-chemical quality of the malt (WO-A-96/34085). One advantage of the selected strain Geotrichum candidum is that it does not produce substances that are toxic and teratogenic to a vertebrate, or substances with genotoxic activities.

A priori, the application of Geotrichum candidum in the malt house is not transferable to the field, principally because of differences in the environment and the sowing methods. In the malt house, sowing is carried out in the liquid medium and in the presence of organic nutrients principally supplied by the grains of barley and at a temperature in the range 15° C. to 20° C. In the field, sowing is carried out by spraying under variable atmospheric conditions.

In particular, the present invention results from studies of the contamination of ears by Fusarium as a function of field spray tests of Geotrichum candidum cultures. Interestingly, said studies have shown an inhibiting effect of Geotrichum candidum on contamination by fungi such as Fusarium sp. They also show a reduction in the presence of mycotoxins and an increase in open field culture yields.

More precisely, the invention provides a method for preventing or treating contamination of cereal by fungi or moulds producing mycotoxins, comprising field spraying an aqueous suspension of spores of a microorganism from the Geotrichum candidum family having the following characteristics:

an absence of mutagenic activity, measured by the Ames test;

an absence of mycotoxin production.

In particular, the fungi or mould producing mycotoxins are from the species Fusarium.

In a preferred implementation of the invention, an aqueous suspension of spores from a strain of Geotrichum candidum derived from yeast used in the malt house is sprayed. More preferably, said spores derive from one of the strains deposited on 6 Sep. 1994 with accession numbers I.1474 and I.1975.

In accordance with the invention, Geotrichum candidum spores are produced using the SKW Biosystems system (PO Box 20, F-77260 LA FERTE-SOUS-JOUARRE). The spores are supplied in solution at an approximate concentration of 5×10⁸ colony-forming units per ml (CFU), termed the mother solution. Prior to spraying, the concentration of Geotrichum candidum is diluted in an aqueous solution in a ratio of 1 to 100.

In a further implementation of the invention, other microorganisms, such as lactic bacteria, with a known effect on biological control of the development of pathogenic microorganisms, are combined with Geotrichum candidum in the aqueous suspension.

The Geotrichum candidum spores are sown by field spraying an aqueous suspension of spores using sprayers that are conventionally used for herbicidal, fungicidal or insecticidal treatments of field cultures.

100 to 150 litres per hectare of a diluted mother solution of spores from the Geotrichum candidum family are sprayed. These values correspond to spraying 10⁹ to 10¹³ spores per hectare. The sowing period is selected from the different stages of growth (tillering, elongation, first node, second node, third node, swelling, flag tip visible, flag ligule out, booting, heading and flowering). Sowing is carried out once or a number of times, at different stages of growth. Preferably, sowing is carried out once at the heading-flowering stage of cereal development.

The invention thus enables cereals contaminated by fungi to be treated. Particular cereals that can be treated are wheat, barley, rye, oats, maize and triticale.

In a particular implementation of the method of the invention, spraying of a suspension of spores from the Geotrichum candidum family is associated with a fungicidal treatment. The results shown in the experimental section of the present text show optimum efficacy in terms of a reduction in mycotoxin production and field culture yield when spraying is carried out in combination with a fungicidal treatment. The fungicidal treatment comprises using any type of fungicidal product either alone or in association using known methods that can reduce contamination by fungal flora or the production of mycotoxins. Examples of fungicides are azoxystobin, bromuconazole, tebuconazole, epoxyconazole and kresoxymethyl. Clearly, the fungicides listed here are not limiting.

The fungicidal treatment is preferably applied at the flag stage of cereal development or at the flowering stage. An example of a fungicidal treatment carried out at the flag stage comprises kresoxymethyl and epoxyconazole. An example of a fungicidal treatment carried out at the flowering stage comprises azoxystobin and bromuconazole. The fungicide can be applied separately from the aqueous suspension comprising the spores or it can be directly added to the aqueous suspension of Geotrichum candidum spores.

The results shown in the examples have demonstrated the effectiveness of using Geotrichum candidum in preventing contamination of cultures by fungi or moulds. Said fungi or moulds are the origin of many diseases such as root rot, oidium, brown rust, septotriosis, helminthosporiosis, leaf blotch and fusariosis.

As a result, the invention concerns the use of a microorganism from the Geotrichum candidum family in producing a preparation that can treat or prevent diseases resulting from contamination of cultures by fungi or mould, in particular root rot, oidium, brown rust, septotriosis, helminthosporiosis, leaf blotch and fusariosis.

Contamination by the development of moulds concerns all agricultural products and more particularly cereals, fruit, vegetables and vines. Said contamination can be accompanied by the production of mycotoxins. Spraying an aqueous suspension of Geotrichum candidum can significantly reduce the quantity of mycotoxins present in agricultural products. As a result, the invention also concerns the use of a Geotrichum candidum microorganism in producing a preparation that can reduce the production of mycotoxins during the growth of cultures of cereals, fruit, vegetables and vines by at least 30% and preferably at least 50%.

More precisely, the microorganisms from the Geotrichum candidum family are used in preparing aqueous suspensions of spores enabling spraying of 10⁹ to 10¹³ spores per hectare. Preferably, the use of a microorganism from the Geotrichum candidum family as described above is combined with one or more fungicides. More preferably, the associated fungicides are selected from azoxystobin, bromuconazole, epoxyconazole and kresoxymethyl, or a combination thereof.

Biological control can also be achieved using a combination of different microorganisms. It may be advantageous to combine the inhibiting effects of a plurality of microorganisms when they are complementary, in particular a fungus and a bacterium. In particular, the invention concerns the use of Geotrichum candidum in combination with other microorganisms such as lactic bacteria, which may play a beneficial role in the biological control of contamination or the production of mycotoxins.

The examples described below demonstrate the feasibility and efficacy of the treatment compared with other fungicidal treatments, without limiting the scope of the method of the invention. In particular, they compare the efficacy of the treatment as a function of the stage at which it is applied and as a function of its association with a fungicidal treatment.

### EXAMPLE 1

### Comparison of the Percentage Contamination of Fusarium and Geotrichum Present on Ears as a Function of the Selected Treatment Method

To quantify the effect of spraying a suspension of Geotrichum candidum, 1 litre of mother solution per hectare containing 5×10¹¹ spores per litre (yeast from the IFBM malt house, produced by SKW Biosystem) was sprayed, after dilution, at different stages of growth to implant Geotrichum candidum onto the ears. The results, as a percentage of contamination by Fusarium and Geotrichum present onto the ears, are shown in Table 1 as a function of the stage at which the treatments were made (flag stage or flowering stage) and of the method used (spraying Geotrichum alone or in combination with a fungicidal treatment). The percentage of contaminated grain was evaluated by depositing grain on a gelose medium and incubating the dishes to allow the contaminating moulds to develop. The fungicidal treatment used was a treatment by spraying with 0.5 litres of 250 g/l azoxystobin (“Amistar” from Zeneca-Sopra) and 0.6 litres of a mixture of 167 g/l bromuconazole and 107 g/l tebuconzole (“Soleil” from Rhône-Poulenc Agro).

TABLE 1

| Stage of treatment | | | |
|---|---|---|---|
| Treatment | | % contamination | |
| Flag | Flowering | Fusarium | Geotrichum |
| Geotrichum | | 87 | 4 |
| | Geotrichum | 70 | 55 |
| | Amistar 0.51 + Soleil | 51 | 62 |
| | 0.61 + Geotrichum | | |
| Geotrichum | Amistar 0.51 + Soleil | 100 | 0 |
| | 0.61 | | |

It has to be remembered that the mode of sowing Geotrichum candidum by spraying is different from that employed in the malt house.

The results clearly show the possibility of obtaining implantation of Geotrichum candidum onto ears by a spray sowing mode. Further, they show that said implantation is accompanied by a reduction in contamination by Fusarium. They also show that optimum efficacy is obtained when spraying is carried out at the flowering stage. Finally, it can be seen that a Geotrichum candidum treatment coupled with a fungicidal treatment (Amistar+Soleil) in the flowering stage allows implantation of Geotrichum candidum with a greater reduction in Fusarium contamination.

These results thus show the efficacy of using strains of Geotrichum candidum in the treatment or prevention of diseases developed by contamination of cultures by fungi or moulds by spraying an aqueous suspension of spores.

### EXAMPLE 2

### Comparison of the Quantity of Mycotoxins Produced and the Culture Yields as a Function of the Selected Treatment Method

The results shown in Tables 2 and 3 intend to show the effect of treatment with Geotrichum candidum on the reduction in the production of mycotoxins during growth. This demonstration was made by assaying deoxynivalenol, the mycotoxin produced by Fusarium, which is the most common in cereals. The experiments were carried out using wheat cultures in test plots of 100 m² (Table 2) in combination with a fungicidal treatment (Amistar and Soleil) and in the open field (several hectares) (Table 3) in combination with a fungicidal treatment by spraying 125 g/l epoxiconazole and 125 g/l kresoxymethyl (OGAM treatment from BASF).

TABLE 2

| Stage of treatment | | | |
|---|---|---|---|
| Treatment | | Mycotoxins | Yield |
| Flag | Flowering | deoxynivalenol, μg/kg | stooks/ha |
| | Amistar 0.51 + Soleil | 2600 | 70.2 |
| | 0.61 | | |
| Geotrichum | Amistar 0.51 + Soleil | 2200 | 70.7 |
| | 0.61 | | |
| | Amistar 0.51 + Soleil | 1700 | 72.5 |
| | 0.61 + Geotrichum | | |

TABLE 3

| | |
|---|---|
| Stage of treatment | |
| Treatment | Mycotoxins |

| Flag | Flowering | Deoxynivalenol, ppb |
|---|---|---|
| OGAM 0.51 | | 400 |
| OGAM 0.51 | Geotrichum | 190 |

It should be noted that the different fungicide/Geotrichum candidum combinations have an amplified effect on mycotoxin reduction when Geotrichum candidum is sprayed at flowering. It should also be observed that this improvement is accompanied by a substantial and significant increase in yields (Table 2). These results indicate that the use of Geotrichum candidum, optionally in combination with a fungicidal treatment enables:

a) the percentage of ears contaminated by Fusarium to be reduced;

b) the production of mycotoxins to be reduced;

c) the yields obtained to be significantly increased.

1. A method for preventing or treating contamination of cereals by fungi or moulds producing mycotoxins, comprising field spraying an aqueous suspension of spores of a microorganism from the Geotrichum candidum family having the following characteristics:
an absence of mutagenic activity, measured by the Ames test;
an absence of mycotoxin production.

2. A method according to claim 1, in which the Geotrichum candidum is a malt house yeast.

3. A method according to claim 2, in which the Geotrichum candidum is one of the strains deposited on 6 Sep. 1994 with accession numbers I.1474 and I.1975.

4. A method according to one of claims 1 to 3, in which the fungi producing the mycotoxins are of the Fusarium species.

5. A method according to claims 1 to 4, in which spraying is carried out in an amount of 10⁹ to 10¹³ spores per hectare.

6. A method according to one of the preceding claims, in which spraying is carried out once at the heading-flowering stage of cereal development or a plurality of times during growth between tillering and flowering.

7. A method according to claim 1, in which the cereals are selected from wheat, barley, rye, oats, maize and triticale.

8. A method according to one of the preceding claims, in which the Geotrichum candidum is combined with other microorganisms, in particular lactic bacteria.

9. A method according to claim 1, in which spraying is combined with a fungicidal treatment.

10. A method according to claim 9, in which the fungicide is selected from azoxystobin, bromuconazole, tebuconazole, epoxyconazole and kresoxymethyl, or a combination thereof.

11. A method according to claim 10, in which the fungicide is applied at the flag stage of cereal development.

12. A method according to claim 10, in which the fungicide is applied during the flowering stage.

13. A method according to claim 12, in which spraying is carried out in the flowering stage.

14. A method according to claim 10, in which the fungicide is added to the aqueous suspension of Geotrichum candidum spores.

15. Use of a microorganism from the Geotrichum candidum family in producing a preparation that can treat or prevent diseases resulting from contamination of cultures by fungi or moulds, in particular root rot, oidium, brown rust, septotriosis, helminthosporiosis, leaf blotch and fusariosis.

16. Use of a microorganism from the Geotrichum candidum family in producing a preparation that can reduce the production of mycotoxins during growth of cultures of cereals, fruit, vegetables or vines by at least 30%, preferably at least 50%.

17. Use according to claim 15 or claim 16, in which the preparation allows 10⁹ to 10¹³ spores per hectare to be sprayed.

18. Use according to claim 15 or claim 16, in which the Geotrichum candidum is combined with other microorganisms, in particular lactic bacteria.

19. Use according to claim 15 or claim 16, in which the Geotrichum candidum is combined with one or more fungicides.

20. Use according to claim 19, in which the fungicide is selected from azoxystobin, bromuconazole, tebuconazole, epoxyconazole and kresoxymethyl, or a combination thereof.
